(19) United States
(12) Patent Application Publication
(10) Pub. No.: US 2026/0221892 A1
(43) Pub. Date: Jul. 30, 2026

(54) INVERTER POWER GENERATION SYSTEMS AND TECHNIQUES

(71) Applicant: Generac Power Systems, Inc., Waukesha, WI (US)

(72) Inventors: Jenia Kuksin, Pacific Palisades, CA (US); Tony Peckler, Pacific Palisades, CA (US); Shehroz Malik, Pacific Palisades, CA (US); Christopher Jones, Pacific Palisades, CA (US)

(73) Assignee: Generac Power Systems, Inc., Waukesha, WI (US)

(21) Appl. No.: 19/451,625

(22) Filed: Jan. 16, 2026

Related U.S. Application Data
(60) Provisional application No. 63/746,826, filed on Jan. 17, 2025.

(51) Int. Cl. H02M 7/00; H02J 3/38; H02J 101/24; H02M 1/00; H02M 3/335; H02M 7/5387

(52) U.S. Cl. CPC H02M 7/003; H02J 3/381; H02M 1/007; H02M 3/33507; H02M 3/33553; H02M 7/5387; H02J 2101/24

(57) ABSTRACT

A power generation system includes an electricity grid, a DC power source, and an inverter. The inverter comprises DC to AC inverter circuitry for converting DC electricity produced by the DC power source to AC power to provide to the electricity grid. The inverter is configured to receive AC electricity from the electricity grid and convert the AC electricity into DC electricity using the DC to AC inverter circuitry to provide DC electricity to peripheral components of the power inverter which provides the power inverter with electrical power while the DC power source is not producing DC electricity.

### CROSS-REFERENCE TO RELATED APPLICATION(S)

This application claims the benefit of and priority to U.S. application Ser. No. 63/746,826, filed on Jan. 17, 2025, titled INVERTER POWER GENERATION SYSTEMS AND TECHNIQUES, the disclosure of which is hereby incorporated by reference in its entirety.

### BACKGROUND

An inverter is a device that is used in home power systems to convert the DC (direct current) electricity generated by a power generation source into AC (alternating current) electricity, which is the type of electricity used in most homes and is compatible with the utility grid.

In a home power system that utilizes photovoltaic (PV) panels, the inverter is used to convert DC electricity generated by one or more of the PV panels into AC electricity. In addition to converting DC to AC electricity, inverters also include monitoring capabilities. They can provide real-time data on the performance of the PV panels, allowing homeowners to easily identify and troubleshoot any issues that may arise.

### SUMMARY

In general terms, this disclosure is directed to a power generation system. In some examples, the power generation system includes an electricity grid, such as, for example, a utility grid, and a DC power source, such as, for example, one or more PV panels, and a power inverter. The power inverter is configured to convert the DC electricity into AC electricity for supplying to the electricity grid when the DC power source is producing DC electricity. Specifically, the power inverter utilizes a DC to AC inverter circuitry to convert the DC electricity into AC electricity. The power inverter is further configured to supply power to various components of the power inverter from the utility grid when the DC power source is not producing DC electricity. To do so, the power inverter utilizes the same DC to AC inverter circuitry hardware in reverse to convert AC electricity from the electricity grid into DC electricity for powering an inverter peripheral load with DC electricity. This provides certain advantages, such as minimizing redundant circuitry within the power inverter and allowing for the components of the power inverter to be powered even when the DC power source is not producing DC electricity.

In some embodiments, and by non-limiting example, a power inverter converts DC electricity from a DC power source into AC electricity for supply to an electricity grid. The power inverter comprises DC to AC inverter circuitry. The power inverter further comprises an input for receiving the DC electricity from the DC power source and an output for providing converted AC electricity to the electricity grid. The converted AC electricity is converted from the DC electricity into the converted AC electricity by the DC to AC inverter circuitry. The power inverter further comprises a peripheral load comprising one or more of a sensor, a gate driver, a communications module, and a controller. The power inverter is configured to provide the peripheral load with converted DC electricity. The converted DC electricity is converted from the AC electricity supplied to the power inverter by the electricity grid though the output. The AC electricity is converted into the converted DC electricity by the DC to AC inverter circuitry.

In other embodiments, and by non-limiting example, a method comprises providing DC electricity produced by a DC power source to an input of a power inverter. The power inverter comprises DC to AC inverter circuitry, the input for receiving the DC electricity from the DC power source; an output for providing converted AC electricity to an electricity grid; and a peripheral load comprising one or more of a sensor, a gate driver, a communications module, and a controller. The method further comprises converting the DC electricity into the converted AC electricity using the DC to AC inverter circuitry. The method further comprises providing the converted AC electricity to the electricity grid. The method further comprises providing AC electricity to the output of the power inverter when the DC power source is not producing the DC electricity. The method further comprises converting the AC electricity into converted DC electricity using the power inverter. The method further comprises providing the converted DC electricity to the peripheral load.

### BRIEF DESCRIPTION OF THE DRAWINGS

FIG. 1 is a system level diagram of an example power generation system.

FIG. 2 is a schematic view depicting portions of an example inverter of the power generation system of FIG. 1.

FIG. 3 is a block diagram of an example circuit arrangement for the power generation system of FIG. 1.

FIG. 4 is a circuit diagram of the circuit arrangement of FIG. 3.

FIG. 5 is a schematic view depicting portions of another example inverter.

FIG. 6 is a block diagram of another example circuit arrangement utilized within another example power generation system in which the inverter of FIG. 5 is included.

FIG. 7 is a circuit diagram of the circuit arrangement of FIG. 6.

FIG. 8 is a detailed circuit diagram of the circuit arrangement shown in FIG. 6.

FIG. 9 is a graphical interface of an oscilloscope depicting voltage readings measured over time at various points on the circuit diagram of FIG. 8.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

An inverter is a device that is used in home power systems to convert the DC (direct current) electricity generated by a power generation source into AC (alternating current) electricity, which is the type of electricity used in most homes and is compatible with the utility grid. Certain inverters are useful for processing DC electricity produced by such power generation sources into forms suitable for the utility grid. This power is then able to be transferred by the inverter onto the grid. In some examples, the DC electricity is produced by power generation sources such as one or more PV panels.

Inverters are used to perform various other tasks, such as monitoring the performance or connection of the PV panels to which they are connected. In some examples, inverters include software which must be updated occasionally to properly perform these functions. Such updates may be useful to perform during times in which the PV panels are not producing energy, as to not interrupt the power supply from the PV panels while the PV panels are producing electricity. Thus, in some examples, it may be useful to provide software updates to inverters during the evening, when the PV panels are producing minimal electricity.

Some inverters are powered by the DC electricity produced by the power generation sources to which they are connected. One problem with such an arrangement is that the inverters are not powered when the power generation sources are not producing electricity, such as, for example, when PV panels are producing minimal electricity during the evening. Thus, certain functions of the inverter (such as PV panel status monitoring functionality) may be unable to be performed during these times. Similarly, due to the lack of power provided to the inverter during these times, software updates for the inverter may need to be delayed until the power generation source is providing electricity, thereby interrupting the power supply from those power generation sources.

The present disclosure describes certain methods and systems for powering inverters using the utility grid to which the inverter is connected. Such systems and methods may be used to provide power to the inverter during times in which the power generation sources are not producing electricity. Thus, the inverter remains able to perform monitoring functions on the power generation sources and software updates during times in which the power generation sources are not producing electricity.

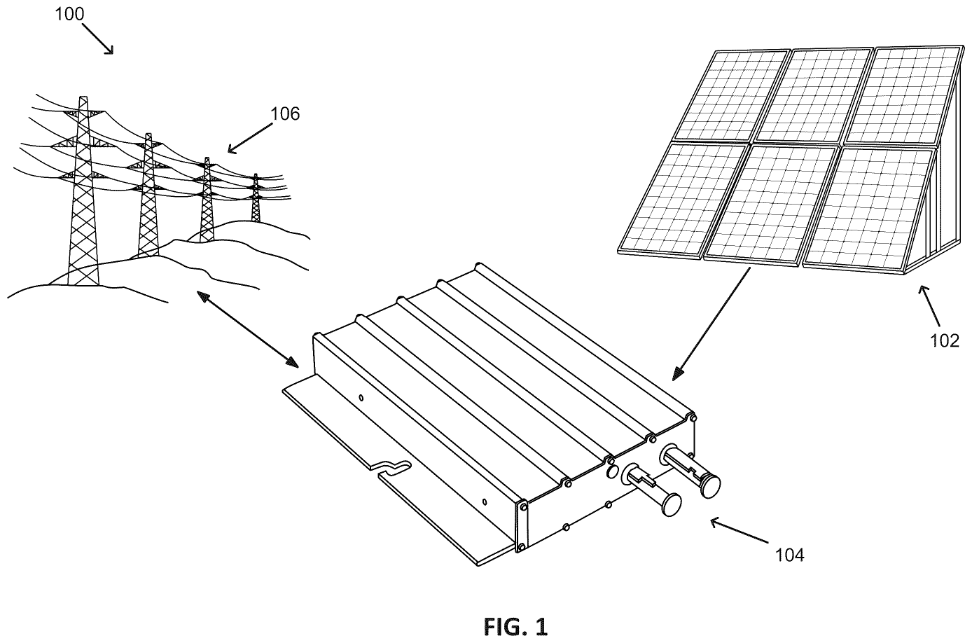

FIG. 1 is a system level diagram of an example power generation system 100. The power generation system 100 comprises a power generation source 102, an inverter 104, and a utility grid 106. The power generation source 102 is electrically connected to the inverter 104, and the utility grid 106 is electrically connected to the inverter 104. The power generation source 102 is connected to the utility grid 106 through the inverter 104. In some examples, the power generation system 100 is utilized to provide electricity produced by the power generation source 102 to the utility grid 106. In some examples, the power generation system 100 is utilized to provide electricity carried over the utility grid 106 to the inverter 104.

In some examples, as indicated by arrow between the power generation source 102 and the inverter 104, the PV panels provide electrical power to the inverter 104. In some examples, as indicated by the arrow between the utility grid 106 and the inverter 104, the inverter provides electrical power to the utility grid 106. In other examples the utility grid 106 provides electrical power to the inverter 104.

The power generation source 102 is configured to produce electricity, such as DC current electricity. In some examples, the power source comprises one or more of a generator, a wind, water, or gas powered turbine, or a PV panel. In some examples, the power generation source 102 comprises multiple PV panels. In other examples, the power generation source 102 consists of a single PV panel.

The utility grid 106 is an interconnected network designed to deliver electricity from produces of electricity to consumers of electricity. In some examples, the utility grid 106 comprises one or more other power generation sources that are separate from the power generation source 102.

The inverter 104 is utilized to convert electricity produced by the power generation source 102 into a format suitable for the utility grid 106. In some examples, the inverter 104 converts DC electricity produced by the power generation source 102 into AC electricity, which is carried over the utility grid 106. In some examples, the DC electricity produced by the power generation source 102 and converted by the inverter is approximately 30V DC. In some examples, the AC electricity that the inverter 104 is used to produce is approximately 120V AC. In other examples, the AC electricity that the inverter 104 is used to produce is approximately 208V AC or 240V AC. In some examples, the inverter 104 comprises any one or more of a single-module microinverter, a dual-module microinverter, a three-phase microinverter, an integrated microinverter, a smart microinverter, and a battery-integrated microinverter.

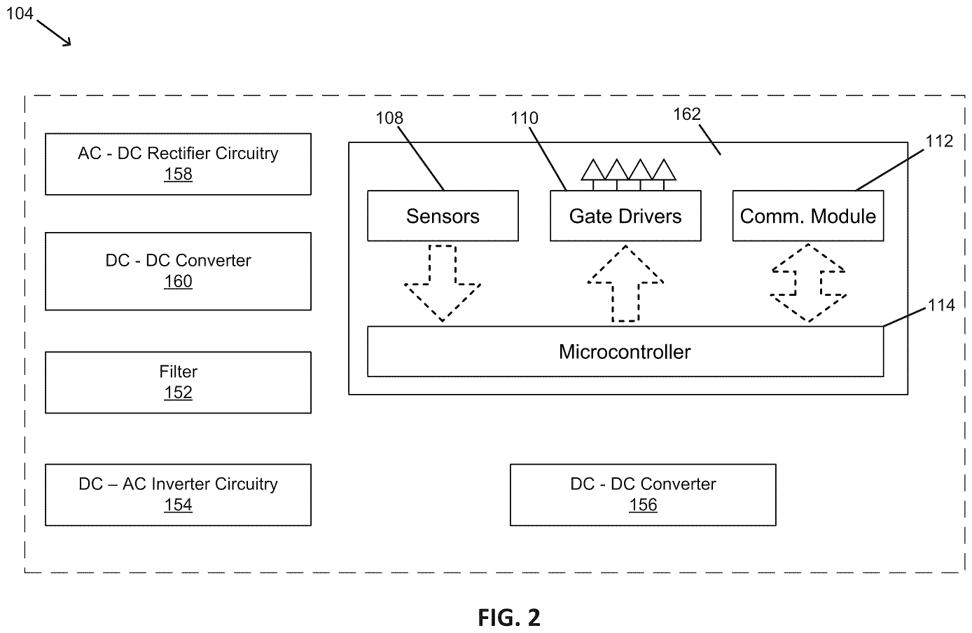

FIG. 2 is a schematic view depicting portions of an example inverter 104. In the example of FIG. 2, the inverter 104 comprises an inverter peripheral load 162, a filter 152, DC to AC inverter circuitry 154, a first DC-DC converter 156, AC to DC rectifier circuitry 158, and a second DC-DC converter 160.

In some examples, the inverter peripheral load 162 comprises one or more sensors 108, one or more gate drivers 110, a communications module 112, and a controller 114. In some examples, the components of the inverter peripheral load require a certain amount of power to operate. In some examples, the power used to operate the inverter peripheral load 162 is referred to as auxiliary power.

The one or more sensors 108 comprise one or more of a voltage sensor, a current sensor. In some examples, the sensors 108 are configured to sense the voltage of

The gate drivers 110 comprise electronic circuits that are designed to control the switching behavior of semiconductors housed within the inverter. Specifically, the gate drivers 110 control the operation of MOSFETs, IGBTs, or other transistors used within various other components of the inverter 104 that to convert DC electricity to AC electricity, or vice versa.

The communications module 112 enables the inverter 104 to transmit and receive data for monitoring, controlling, and optimizing the performance of various aspects of the power generation system 100. In some examples, the communications module 112 facilitates communication between other inverters of the power generation system 100 or facilitates communication between the inverter 104 a central controller or external monitoring devices for the power generation system 100.

The controller 114 is utilized to manage and control the operation of the inverter 104. In some examples, the controller 114 comprises a microcontroller. The controller 114 receives signals from and sends signals to other components of the inverter 104. Specifically, as illustrated by the arrows of FIG. 2, the controller 114 receives signals from the sensors 108, sends signals to the gate drivers 110, and sends and receives signals to and from the communications module 112.

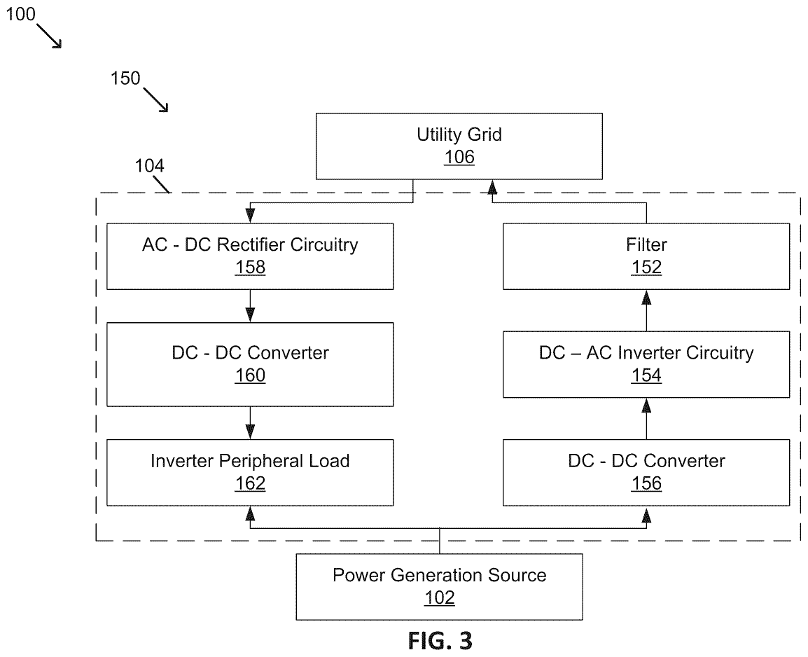

FIG. 3 is a block diagram of an example circuit arrangement 150 for the power generation system 100. As shown in FIG. 3, the example circuit arrangement 150, includes the utility grid 106, the inverter 104, and the power generation source 102. As shown in the example of FIG. 3, the inverter 104 includes the filter 152, DC to AC inverter circuitry 154, first DC-DC converter 156, AC to DC rectifier circuitry 158, second DC-DC converter 160, and inverter peripheral load 162.

In some embodiments, certain components of the example circuit arrangement 150 are housed within the inverter 104. In some examples, the filter 152, DC to AC inverter circuitry 154, first DC-DC converter 156, AC to DC rectifier circuitry 158, second DC-DC converter 160, and inverter peripheral load 162 is housed within the inverter 104. In some examples, the circuit arrangement 150 allows for the inverter peripheral load 162 to be powered using electricity received from the utility grid 106 or power received from the power generation source 102.

In some examples, the filter 152 is used to remove unwanted harmonic distortions or electromagnetic interference (EMI) in the AC electricity output that is provided to the utility grid 106 from the power generation source 102 by the inverter 104. In some examples, the filter comprises one or more of a low-pass filter, an LC filter, and an EMI filter.

The DC to AC inverter circuitry 154 is used to convert the DC electricity output of the power generation source 102 into an AC electricity output that can be sent to the utility grid 106. In some examples, the DC to AC inverter circuitry 154 comprises an input at which DC electricity is received and an output from which AC electricity is produced. In some examples, the DC to AC inverter circuitry 154 comprises one or more transistors and/or one or more capacitors. In some examples, the DC to AC inverter circuitry 154 comprises an H-bridge. In some examples, the DC to AC inverter circuitry 154 comprises four MOSFET transistors which form an H-bridge and are connected to a DC-link capacitor.

The first DC-DC converter 156 is used to convert the voltage value of the output of the DC electricity from the power generation source 102 to another DC electricity voltage value. Specifically, in the example circuit arrangement 150, the first DC-DC converter 156 is used to step up the voltage value of the output of the DC electricity from the power generation source 102 from approximately 30V DC to approximately 350V DC. In some examples, the first DC-DC converter 156 comprises multiple DC-DC converters. In some examples, the first DC-DC converter 156 comprises one or more of an asynchronous buck DC-DC converter and a flyback DC-DC converter. In some examples, the presence of the DC-DC converter causes the power generation source 102 to be galvanically isolated from the utility grid 106

The AC to DC rectifier circuitry 158 is used to convert AC electricity received from the utility grid 106 into DC electricity that can be used to power the inverter peripheral load 162. In some examples, the AC to DC rectifier circuitry 158 comprises an input at which AC electricity is received and an output from which DC electricity is produced. In some examples, the AC to DC rectifier circuitry 158 comprises one or more diodes. In some examples, the AC to DC rectifier circuitry 158 comprises four diodes which form an H-bridge and are connected to a DC-link capacitor. In other examples, the AC to DC rectifier circuitry 158 is similar in many aspects to the DC to AC inverter circuitry 154.

The second DC-DC converter 160 is used to convert the voltage value of the DC electricity received from the AC to DC rectifier circuitry 158 into another voltage value that can be used to power the inverter peripheral load 162. In some examples, the second DC-DC converter 160 is used to reduce the voltage value of the DC electricity received from the AC to DC rectifier circuitry 158. In some examples, the second DC-DC converter 160 is similar in many aspects to the first DC-DC converter 156.

In some examples, the inverter peripheral load 162 comprises one or more of the sensors 108, the gate drivers 110, the communications module 112, and the controller 114, as previously shown and described with reference to FIG. 2.

In the circuit arrangement 150, electricity flows through the circuit arrangement 150 in various paths.

In a first path, DC electricity flows from the power generation source 102 to the DC-DC converter 156, where the voltage value of the DC electricity is increased. The DC electricity then flows into the DC to AC inverter circuitry 154, where the DC electricity is converted into AC electricity. The AC electricity flows through the filter 152, where it is converted into a suitable form for the grid. The filtered AC electricity then flows into the utility grid 106.

In a second path, DC electricity flows from the power generation source 102 to the inverter peripheral load 162, where it is used to power the inverter peripheral load 162.

In a third path, AC electricity flows from the utility grid 106 to the AC to DC rectifier circuitry 158, where it is converted into DC electricity. The DC electricity flows from the AC to DC rectifier circuitry 158 to the DC-DC converter 160 where the voltage value of the DC electricity is reduced. The DC electricity then flows to the inverter peripheral load 162 where it is used to power the inverter peripheral load 162.

In some examples, in order for the electricity to flow as described in the first path, the power generation source 102 needs to be producing electricity. Thus, the power generation source 102 is unable to provide electrical power to the inverter peripheral load 162 when the power generation source 102 is not producing electricity, such as, for example, when PV panels cease producing electricity in the evening. Thus, the third path allows for the inverter peripheral load 162 to be powered by the utility grid 106 when the power generation source 102 is not producing electricity.

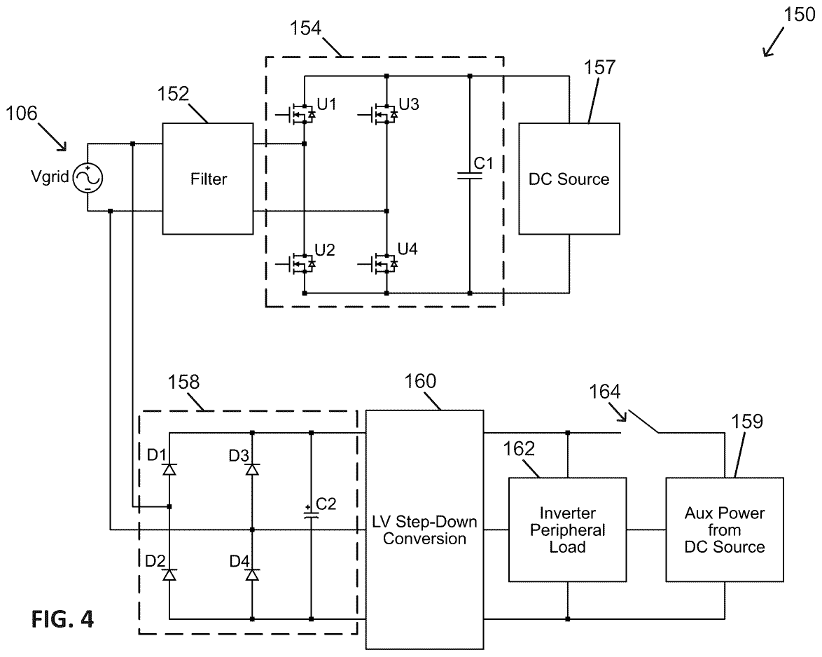

FIG. 4 is a circuit diagram of the circuit arrangement 150 of the example circuit block diagram of FIG. 3. In the example of FIG. 4, the circuit arrangement 150 further comprises a DC power source 157, an auxiliary DC source 159, and a switch 164. In some examples, the DC power source 157 comprises the power generation source 102. In some examples, the DC power source 157 further comprises the DC-DC converter 156. In some examples, the auxiliary DC source 159 also comprises the power generation source 102.

As shown in the example of FIG. 4, the DC to AC inverter circuitry 154 comprises an H-bridge comprised of four MOSFET transistors U1, U2, U3, U4. In the example of FIG. 4, the DC to AC inverter circuitry 154 further comprises a DC-link capacitor C1. In some examples the DC link capacitor C1 is a film capacitor. In other examples, the DC link capacitor is an electrolytic capacitor.

Furthermore, as shown in the example of FIG. 4, the AC to DC rectifier circuitry 158 is comprised of an H-bridge comprised of four diodes D1, D2, D3, D4. In the example of FIG. 4, the AC to DC rectifier circuitry 158 further comprises a second capacitor C2. In some examples, the second capacitor C2 is a dedicated decoupling capacitor. In some examples, the second capacitor C2 is an electrolytic capacitor. In some examples, the second DC link capacitor is a film capacitor.

In the example of FIG. 4, the utility grid 106 is electrically connected to the filter 152, the filter 152 is electrically connected to the DC to AC inverter circuitry 154, the DC to AC inverter circuitry 154 is electrically connected to a DC power source 157. In some examples, the DC power source 157 comprises the power generation source 102. In some examples, the DC power source 157 further comprises the DC-DC converter 156. The utility grid 106 is further electrically connected to the AC to DC rectifier circuitry 158. The AC to DC rectifier circuitry 158 is electrically connected to the DC - DC converter 160. The DC-DC converter is electrically connected to the inverter peripheral load 162. The inverter peripheral load 162 is electrically connected to the auxiliary DC source 159. In some examples, the auxiliary DC source 159 comprises the power generation source 102. Thus, in some examples, each of the DC to AC inverter circuitry 154 and the inverter peripheral load 162 are electrically connected to the power generation source 102.

In some examples, the switch 164 is arranged between the inverter peripheral load 162 and the auxiliary DC power source 159. In some examples, opening of the switch 164 allows for electricity to flow according to the third path, described above with reference to FIG. 3. In some examples, closing of the switch 164 allows for electricity to flow according to the second path, described above with reference to FIG. 3.

In some examples, the sensors 108 of the inverter 104 are used to measure certain electrical signals in the circuit arrangement 150. In some examples, the sensors 108 comprise a voltage sensor that measures the voltage across the utility grid 106. In some examples, the sensors 108 comprise a voltage sensor that measures the voltage across the capacitor C1 of the DC to AC inverter circuitry 154. In some examples, the sensors 108 comprise a current sensor that measures the current between the filter 152 and the utility grid 106.

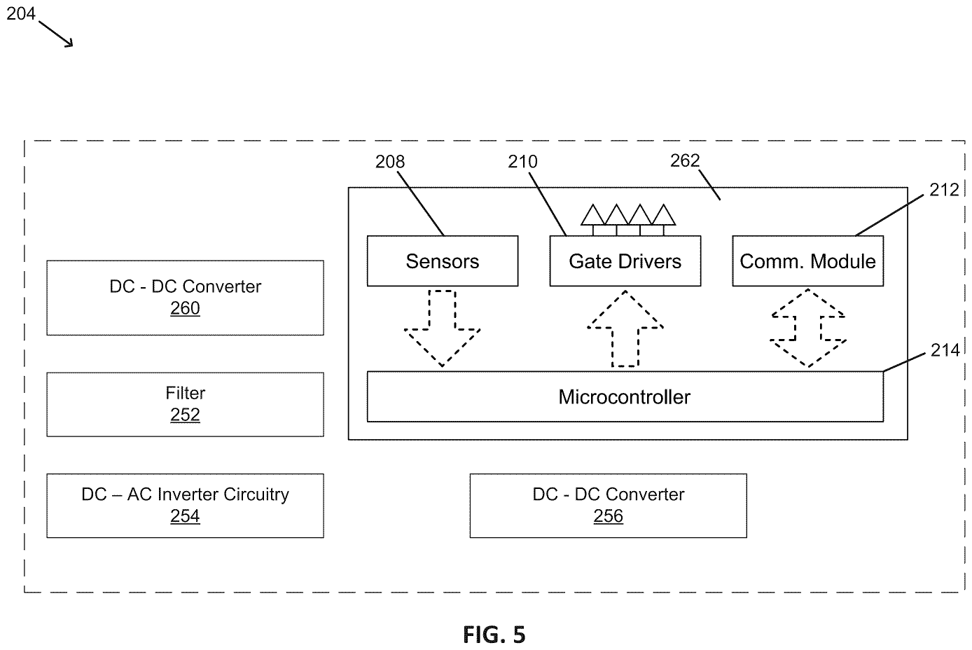

FIG. 5 is a schematic view depicting portions of another example inverter 204. In the example of FIG. 5, the inverter 204 comprises an inverter peripheral load 262, a filter 252, DC to AC inverter circuitry 254, a first DC-DC converter 256, and a second DC-DC converter 260. In contrast to the inverter 104, in some examples, the inverter 204 does not comprise any additional AC to DC rectifier circuitry 158. Likewise, in some examples, the inverter 204 does not comprise a second DC-DC converter 260.

In some examples, each of the inverter peripheral load 262, the filter 252, the DC to AC inverter circuitry 254, the first DC-DC converter 256, and the second DC-DC converter 260 are similar in many aspects to the respective inverter peripheral load 162, the filter 152, the DC to AC inverter circuitry 154, the first DC-DC converter 156, and the second DC-DC converter 160 of the inverter 104.

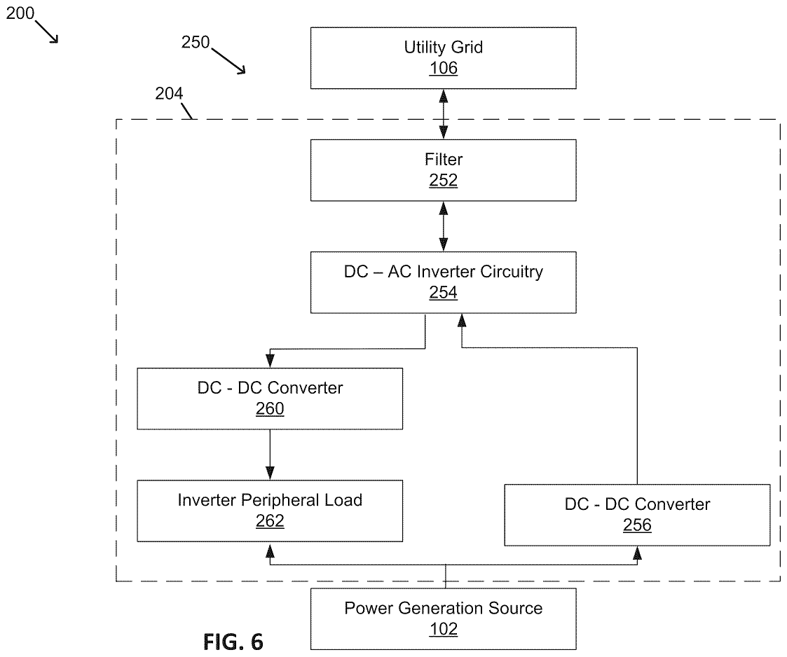

FIG. 6 is a block diagram of another example circuit arrangement 250 used within another power generation system 200. In some examples, the power generation system 200 is similar in many aspects to the power generation system 100. In some examples, the power generation system 200 differs from the power generation system 100 in that it utilizes the inverter 204 instead of the inverter 104.

As shown in the example of FIG. 6, power generation system 200 utilizes the example circuit arrangement 250. As shown in FIG. 6, the example circuit arrangement 250, includes the utility grid 106, the inverter 204, and the power generation source 102. Additionally, the circuit arrangement includes a filter 252, DC to AC inverter circuitry 254, a first DC-DC converter 256, a second DC-DC converter 260, and an inverter peripheral load 262.

In some examples, the filter 252, DC to AC inverter circuitry 254, first DC-DC converter 256, second DC-DC converter 260, and the inverter peripheral load 262 are similar in many aspects to the filter 152, DC to AC inverter circuitry 154, first DC-DC converter 156, second DC-DC converter 160, and the inverter peripheral load 162, respectively.

As noted above, in contrast to the inverter 104 and circuit arrangement 150, in some examples, the inverter 204 and circuit arrangement 250 does not comprise any additional AC to DC rectifier circuitry 158. Thus, in some examples, the inverter 204 and circuit arrangement does not include a dedicated decoupling capacitor.

In the circuit arrangement 250, electricity flows through the circuit arrangement 250 in various paths.

In a first path, DC electricity flows from the power generation source 102 to the DC-DC converter 256, where the voltage value of the DC electricity is increased. The DC electricity then flows into the DC to AC inverter circuitry 254, where the DC electricity is converted into AC electricity. The AC electricity flows through the filter 252, where it is converted into a suitable form for the utility grid 106. The filtered AC electricity then flows into the utility grid 106.

In a second path, DC electricity flows from the power generation source 102 to the inverter peripheral load 262, where it is used to power the inverter peripheral load 262.

In a third path, AC electricity flows from the utility grid 106 to the output of the DC to AC inverter circuitry 254, where it is converted from AC electricity to DC electricity. The DC electricity flows from the input of the DC to AC inverter circuitry 254 to the DC-DC converter 260 where the voltage value of the DC electricity is reduced. The DC electricity then flows to the inverter peripheral load 262 where it is used to power the inverter peripheral load 262.

In some examples, such as wherein the inverter 204 does not comprise the second DC-DC converter 260, in the third path, AC electricity flows from the utility grid 106 to the output of the DC to AC inverter circuitry 254, where it is converted from AC electricity to DC electricity. The DC electricity flows from the input of the DC to AC inverter circuitry 254 to the DC-DC converter256 where the voltage value of the DC electricity is reduced. The DC electricity then flows to the inverter peripheral load 262 where it is used to power the inverter peripheral load 262.

In some examples, in order for the electricity to flow as described in the first path, the power generation source 102 needs to be producing electricity. Thus, the power generation source 102 is unable to provide electrical power to the inverter peripheral load 262 when the power generation source 102 is not producing electricity, such as, for example, when PV panels cease producing electricity in the evening. Thus, the third path allows for the inverter peripheral load 262 to be powered by the utility grid 106 when the power generation source 102 is not producing electricity.

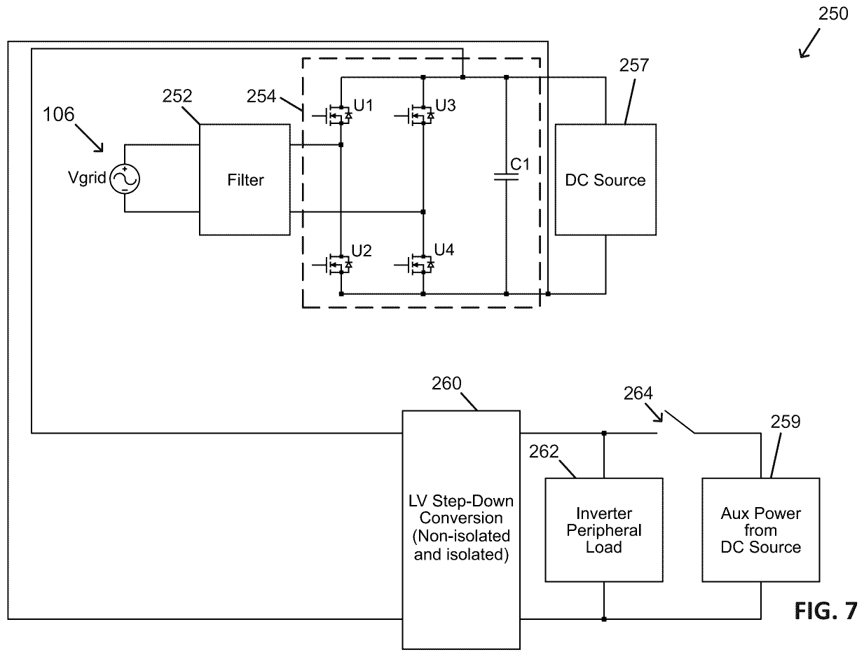

FIG. 7 is a circuit diagram of the circuit arrangement 250 of the example circuit block diagram of FIG. 6. In the example of FIG. 7, the circuit arrangement 250 further comprises a DC power source 257, an auxiliary DC power source 259, and a switch 264. In some examples, the DC power source 257 comprises the power generation source 202. In some examples, the DC power source 257 further comprises one or more DC-DC converters, such as the DC-DC converter 256. In some examples, the auxiliary DC power source 259 also comprises the power generation source 102.

In the example of FIG. 7, the utility grid 106 is electrically connected to the filter 252, the filter 252 is electrically connected to the DC to AC inverter circuitry 254, the DC to AC inverter circuitry 254 is electrically connected to the DC power source 257. In some examples, the DC power source 257 comprises the power generation source 102. In some examples, the DC power source 257 further comprises the DC-DC converter 256.

In contrast to FIG. 4, in some examples, as shown in FIG. 7, the utility grid 106 is not electrically connected to any additional AC to DC rectifier circuitry. Instead, in some examples, the second DC-DC converter 260 is electrically connected across the DC input of the DC to AC inverter circuitry 254. The second DC-DC converter 260 is electrically connected to the inverter peripheral load 262. The inverter peripheral load 262 is electrically connected to the auxiliary DC power source 259. In some examples, the auxiliary DC power source 259 comprises the power generation source 102. Thus, in some examples, each of the DC to AC inverter circuitry 254 and the inverter peripheral load 262 are electrically connected to the power generation source 102.

In some examples, the switch 264 is arranged between the inverter peripheral load 262 and the auxiliary DC power source 259. In some examples, opening of the switch 264 allows for electricity to flow according to the third path, described above with reference to FIG. 6. In some examples, closing of the switch 264 allows for electricity to flow according to the second path, described above with reference to FIG. 6.

In some examples, the sensors 208 of the inverter 204 are used to measure certain electrical signals in the circuit arrangement 250. In some examples, the sensors 208 comprise a voltage sensor that measures the voltage across the utility grid 106. In some examples, the sensors 208 comprise a voltage sensor that measures the voltage across the capacitor C1 of the DC to AC inverter circuitry 254. In some examples, the sensors 208 comprise a current sensor that measures the current between the filter 252 and the utility grid 106.

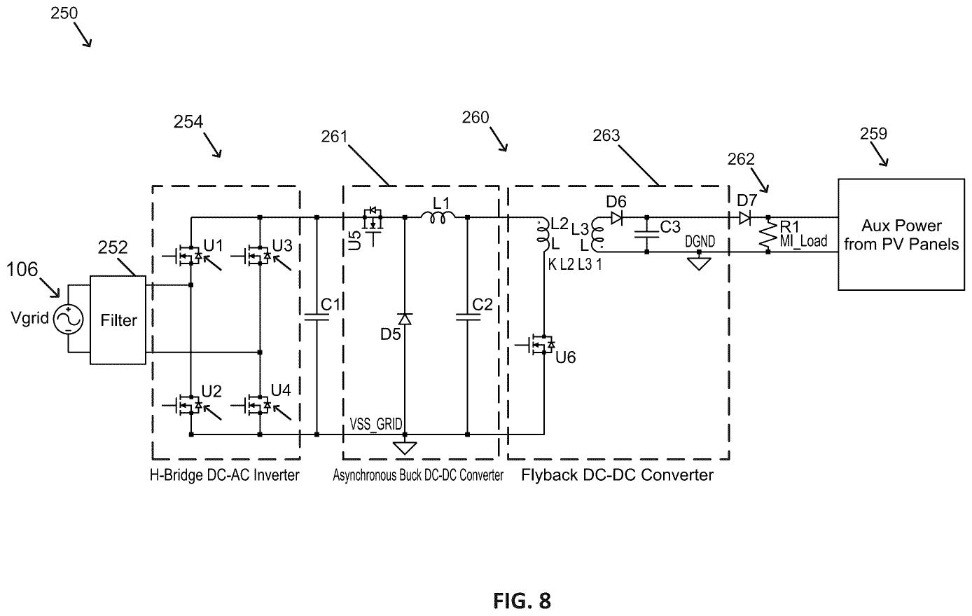

FIG. 8 is a detailed circuit diagram of the circuit arrangement 250 shown in FIG. 6. As shown in the example of FIG. 8, the DC-DC converter 260 comprises a plurality of DC-DC converters, including an asynchronous buck DC-DC converter 261 and a flyback DC-DC converter 263. In some examples, the asynchronous buck DC-DC converter 261 comprises a MOSFET U5, diode D5, an inductor L1, and a capacitor C2. In some examples, the flyback DC-DC converter comprises a MOSFET U6, inductors L2, L3, capacitor C3. In some examples, the circuit arrangement 250 further comprises a diode D7 arranged between the flyback DC-DC converter 263 and the inverter peripheral load 262.

As noted above with reference to FIG. 6, electricity flows through the circuit arrangement 250 through the first path, the second path, and the third path. In some examples, with reference to the detailed circuit diagram of FIG. 8, in the first path, DC electricity is supplied by the auxiliary DC power source 259. The voltage of the DC electricity is then increased through the flyback DC-DC converter 263, and is increased again through the asynchronous buck DC-DC converter 261. The DC electricity is then converted to AC electricity through the DC to AC inverter circuitry 254 and filtered by the filter 252, after which it is supplied to the grid 106.

In the second path, DC electricity is supplied by the auxiliary DC power source 259 to the inverter peripheral load 262, where it is used to power the inverter peripheral load 262.

In the third path, AC electricity flows from the utility grid 106 to the DC to AC inverter circuitry 254, where it is converted from AC electricity to DC electricity utilizing the parasitic rectification path of the DC to AC inverter circuitry 254. The DC electricity flows from the DC to AC inverter circuitry 254 to the asynchronous buck DC-DC converter 261 where the voltage is decreased. The DC electricity then flows through the Flyback DC-DC converter 263, where the voltage is again decreased. The electricity is subsequently delivered to the inverter peripheral load 262, where it is used to power the inverter peripheral load 262.

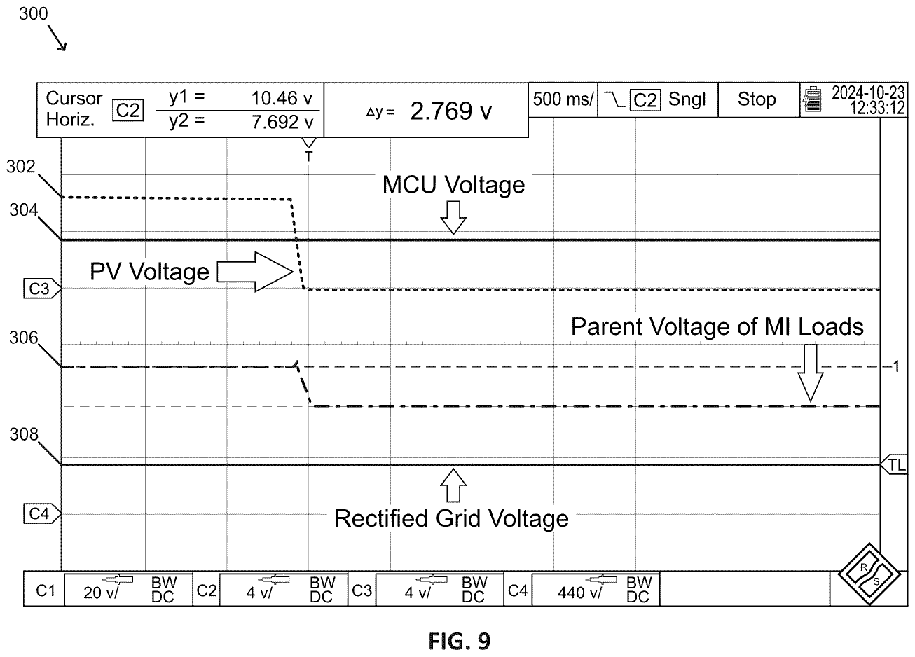

FIG. 9 is a graphical interface 300 of an oscilloscope depicting voltage readings measured over time at various points on the circuit arrangement 250 of FIG. 8. In some examples, the voltage readings depicted in FIG. 9 reflect voltage readings measured by the sensors 208 of the inverter 204. In some examples, the graphical interface comprises lines 302, 304, 306, and 308.

In some examples, grid line 302 depicts the voltage measured across the output of a DC power source that feeds into the auxiliary DC power source 259. The grid line 304 depicts the voltage received by the controller 214 of the inverter 204. The grid line 306 depicts the voltage received by the inverter peripheral load 262. And the grid line 308 depicts the voltage of the rectified DC electricity measured across the DC link capacitor C1.

In some examples, starting at the left end of the graphical interface 300, as shown by line 302, the voltage across the DC power source begins at a first voltage, such as, for example, approximately 30V. In some examples, as the DC power source outputs the first voltage, the inverter peripheral load 262 receives a second voltage from the auxiliary DC power source 259, shown by grid line 306. In some examples, the first voltage is stepped down by a DC-DC converter to generate the second voltage. In some examples, the second voltage is approximately 10.5V. Over time, the voltage across the outputs of the DC power source may decrease to a third voltage, such as, for example, in the case where PV panels no longer output power during nighttime conditions. In some examples, the third voltage is approximately 0V.

In some examples, the voltage of the rectified DC electricity measured across the DC link capacitor C1, shown by grid line 308, remains constant at a fourth voltage. In some examples, the fourth voltage is approximately 350V. In some examples, the fourth voltage is stepped down using the DC-DC converter 260. Specifically, in some examples, the fourth voltage is stepped down using the asynchronous buck DC-DC converter 261. In some examples, the fourth voltage is stepped down from approximately 350V to approximately 12V. In some examples, the fourth voltage is stepped down further using the flyback DC-DC converter 263. In some examples, the flyback DC-DC converter 263 steps down the fourth voltage from approximately 12V to approximately 7.6V. In some examples, the flyback DC-DC converter 263 galvanically isolates the 12V stepped down fourth voltage from the 7.6V stepped down fourth voltage.

In some examples, the stepped down fourth voltage is supplied to the inverter peripheral load 262 when the voltage provided by DC power source drops to the third voltage (i.e. drops to 0V). In some examples, when the voltage supplied by the DC power source drops to the third voltage, the inverter 204 is configured to supply the components of the inverter peripheral load 262 with a fifth voltage, shown by grid line 306. In some examples, as shown by grid line 306, the fifth voltage is less than the second voltage. In some examples, the fifth voltage is greater than zero and less than the second voltage. In some examples, the fifth voltage is approximately 7.6V. In some examples, the fifth voltage is generated by stepping down the fourth voltage using the asynchronous buck DC-DC converter 261 and the flyback DC-DC converter 263.

In some examples, as shown by grid line 304, despite the drop in voltage across the inverter peripheral load 262, indicated by grid line 306, the voltage supplied to the controller 214 remains constant. In some examples, the voltage supplied to the controller 214 remains at a constant 3.5V. Thus, in some examples, the voltage supplied to the controller 214 remains at a constant voltage as the power supplied to the inverter peripheral load 262 switches from the auxiliary DC power source 259 to the rectified DC electricity provided by the utility grid 106. In some examples, the constant voltage supplied to the controller 214 is generated through a flexible parent rail of the inverter 204, which is configured to convert the input voltages from either one of the auxiliary DC power source 259 or the rectified DC electricity of the utility grid 106 to the same output value for the controller 214.

In some examples, the circuit arrangement 250 offers various advantages. In some examples, these examples are achieved by way of not incorporating the AC to DC rectifier circuitry 158 and instead utilizing the DC to AC inverter circuitry 254 to convert the AC electricity from the utility grid 106 into DC electricity for powering the inverter peripheral load 262. In doing so, the circuit arrangement 250 provides an enhanced lifespan of the circuit because the dedicated decoupling capacitor C2 of the AC to DC rectifier circuitry 158 is omitted from the circuit arrangement 250. The omission of the dedicated decoupling capacitor C2 of the AC to DC rectifier circuitry 158 allows for film capacitors to be utilized within the circuit arrangement 250 as opposed to electrolytic capacitors, which, in some examples, have a greater lifespan than electrolytic capacitors.

In some examples, by omitting the AC to DC rectifier circuitry 158, the circuit arrangement 250 provides a simpler design than the circuit arrangement 150. This simpler design and omission of the dedicated decoupling capacitor C2 allows for a smaller circuit footprint.

In some examples, by utilizing the asynchronous buck DC-DC converter 261 and the flyback DC-DC converter 263 to convert the rectified DC electricity from the utility grid 106, the circuit arrangement 250 allows for flexible power delivery by providing both isolated and non-isolated power to the circuit.

In some examples, the circuit arrangement 250 also provides the advantage of providing for a reliable power supply to the inverter peripheral load 262 of the inverter 204, regardless of whether power is available from the DC power source, such as, for example, a PV panel.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A power inverter for converting DC electricity from a DC power source into AC electricity for supply to an electricity grid, the power inverter comprising:
DC to AC inverter circuitry;
an input for receiving the DC electricity from the DC power source;
an output for providing converted AC electricity to the electricity grid, the converted AC electricity being converted from the DC electricity into the converted AC electricity by the DC to AC inverter circuitry; and
a peripheral load comprising one or more of a sensor, a gate driver, a communications module, and a controller, the power inverter being configured to provide the peripheral load with converted DC electricity, the converted DC electricity being converted from the AC electricity supplied to the power inverter by the electricity grid though the output, the AC electricity being converted into the converted DC electricity by the DC to AC inverter circuitry.

2. The power inverter of claim 1, further comprising a filter for filtering the converted AC electricity before providing the converted AC electricity to the electricity grid.

3. The power inverter of claim 1, further comprising a DC-DC converter.

4. The power inverter of claim 3, wherein the DC-DC converter comprises a flyback converter.

5. The power inverter of claim 4, wherein the DC-DC converter further comprises an asynchronous buck DC-DC converter.

6. The power inverter of claim 5, wherein the DC-DC converter is configured to increase the voltage of the DC electricity.

7. The power inverter of claim 6, wherein the DC-DC converter is configured to decrease the voltage of the converted DC electricity before the converted DC electricity is provided to the peripheral load.

8. The power inverter of claim 1, wherein the DC to AC inverter circuitry comprises an H-bridge comprising a plurality of transistors.

9. The power inverter of claim 1, wherein the DC power source comprises one or more PV panels.

10. The power inverter of claim 1, wherein the peripheral load is galvanically isolated from the DC to AC inverter circuitry.

11. The power inverter of claim 1, wherein the power inverter does not comprise a dedicated decoupling capacitor.

12. A method comprising:
providing DC electricity produced by a DC power source to an input of a power inverter, the power inverter comprising:
DC to AC inverter circuitry;
the input for receiving the DC electricity from the DC power source;
an output for providing converted AC electricity to an electricity grid; and
a peripheral load comprising one or more of a sensor, a gate driver, a communications module, and a controller;
converting the DC electricity into the converted AC electricity using the DC to AC inverter circuitry;
providing the converted AC electricity to the electricity grid;
providing AC electricity to the output of the power inverter when the DC power source is not producing the DC electricity;
converting the AC electricity into converted DC electricity using the power inverter; and
providing the converted DC electricity to the peripheral load.

13. The method of claim 12, wherein the DC power source is a PV panel.

14. The method of claim 12, wherein the DC to AC inverter circuitry comprises a plurality of transistors.

15. The method of claim 14, wherein the plurality of transistors comprises a plurality of MOSFETs.

16. The method of claim 15, wherein the plurality of transistors comprises four transistors arranged in an H-bridge.

17. The method of claim 12, further comprising providing the DC electricity produced by the DC power source to the peripheral load when the DC power source is producing the DC electricity.

18. The method of claim 12, wherein the power inverter does not comprise an electrolytic capacitor.

19. The method of claim 12, wherein the AC electricity comprises a voltage value of 240V.

20. The method of claim 12, wherein the DC to AC inverter circuitry comprises a DC-link capacitor.

21. The method of claim 12, further comprising galvanically isolating the peripheral load from the DC to AC inverter circuitry using a flyback converter.

22. The method of claim 12, wherein the peripheral load comprises the controller, and wherein the power inverter comprises a flexible parent rail that is configured to supply the controller with a constant voltage DC electricity.
